(19) United States
(12) Patent Application Publication
(10) Pub. No.: US 2016/0332406 A1
(43) Pub. Date: Nov. 17, 2016

(54) MISTING DEVICE

(71) Applicant: GYRE INNOVATIONS LP, York, PA (US)

(72) Inventors: Clay TULLY, Hummelstown, PA (US); Stephen METTEE, II, Red Lion, PA (US); Stephen W. TANSEY, York, PA (US)

(21) Appl. No.: 14/710,033

(22) Filed: May 12, 2015

(51) Int. Cl. B31B 1/74

(52) U.S. Cl. CPC B31B 1/74

(57) ABSTRACT

A misting device includes a nozzle in close proximity to an article moving relative to the nozzle and a sensor for sensing a position of the article relative to the nozzle. In response to the sensor sensing a predetermined position of the article relative to the nozzle, a pressurized mist is selectively provided substantially only to a surface of a predetermined portion of the article facing the nozzle prior to at least one subsequent processing step of the article. The predetermined portion of the surface is conditioned by the pressurized mist and the predetermined portion of the surface remains conditioned during the at least one subsequent processing step of the article.

### BACKGROUND

The present invention is directed to a misting device, and more particularly to a misting device and method associated with manufacturing products.

In its basic form, corrugated fiberboard consists of a single corrugated layer or medium sandwiched between two liner layers. Corrugated fiberboard for use as boxes are often cut into large sheets referred to as box blanks, which are subsequently trimmed, cut, scored, folded and glued to form the box.

There are challenges associated with producing boxes, especially for boxes having multiple wall thicknesses. These challenges include cracking of liners during scoring of creases or folds, as well as resulting folds that are not straight or are not properly positioned.

It would be desirable in the art to address the above challenges while maintaining a high rate of manufacture.

### SUMMARY

One embodiment of the invention is directed to an apparatus for use with the manufacture of corrugated fiberboard products including a first nozzle in close proximity to a corrugated fiberboard sheet having a crease formed in a predetermined portion of the sheet, the sheet moving relative to the first nozzle. A sensor for sensing a position of the sheet relative to the first nozzle. In response to the sensor sensing a predetermined position of the sheet relative to the first nozzle, a pressurized mist is selectively provided substantially only to a surface of the predetermined portion of the sheet facing the first nozzle prior to formation of a fold in the crease.

Another embodiment of the invention is directed to a method for manufacturing corrugated fiberboard products including moving a fiberboard sheet having a crease formed in a predetermined portion of the sheet, the sheet in close proximity relative to a nozzle providing a pressurized mist. The method further includes sensing a predetermined position of the sheet relative to the nozzle and selectively providing the pressurized mist substantially only to a surface of the predetermined portion of the sheet facing the nozzle for conditioning the predetermined portion. The method further includes forming a fold in the crease.

Yet another embodiment of the invention is directed to a misting device including a nozzle in close proximity to an article moving relative to the nozzle and a sensor for sensing a position of the article relative to the nozzle. In response to the sensor sensing a predetermined position of the article relative to the nozzle, a pressurized mist is selectively provided substantially only to a surface of a predetermined portion of the article facing the nozzle prior to at least one subsequent processing step of the article. The predetermined portion of the surface is conditioned by the pressurized mist and the predetermined portion of the surface remains conditioned during the at least one subsequent processing step of the article.

### BRIEF DESCRIPTION OF THE FIGURES

FIG. 1 shows an upper frontal perspective view of an exemplary embodiment of a misting device.

FIG. 2 shows a partial, enlarged view of the misting device taken from region 1 of FIG. 1.

FIG. 3 shows an upper elevation perspective view of an exemplary embodiment of a misting device.

FIG. 4 shows a partial, enlarged view of the misting device taken from region 2 of FIG. 3.

FIG. 5 shows a plan view of an exemplary embodiment of a box blank having conditioned regions bridge.

### DETAILED DESCRIPTION OF EXEMPLARY EMBODIMENTS

Exemplary embodiments are directed to an apparatus or misting device and subassemblies and components of a misting device that overcome drawbacks associated with such conventional devices. While discussed in the context of a particular misting device, it will be appreciated that all of the aspects of that misting device are not required to be used in combination. Rather any one of the components or subassemblies can be separately employed in conjunction with otherwise conventional misting devices or otherwise combined in any manner desired.

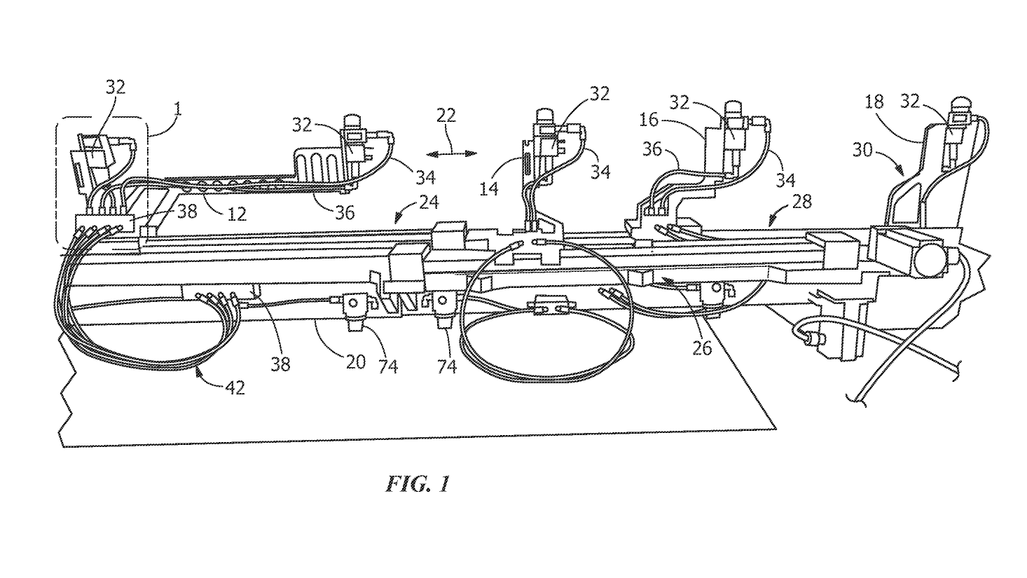

Referring to FIG. 1, an apparatus or misting device 10 includes a plurality of movable support members 12, 14, 16, 18 structurally carried by a frame 20. Support members 12, 14, 16, 18 are selectively urged into a movement direction 22 by respective conveyors 24, 26, 28, 30. Electromechanical devices, such as electro pneumatic valves 32 are each provided with pressurized vapor, such as air, and pressurized liquid, such as water, from a pressurized vapor source (not shown) and a pressurized liquid source (not shown) via respective vapor conduits 34 and liquid conduits 36 connected in series with a corresponding metering device 40 to produce a pressurized mist. In other embodiments, a suitable vapor other than air (or mixture of air and another vapor) and/or a suitable liquid other than water (or a mixture of water and another liquid) may be used. In these embodiments, the proportions of air/other vapor as well as the proportions of water/other liquid may vary considerably due to, for example, the parameters of the container being produced, as well as the weight of the paperboard layers and central medium positioned therebetween, as well as the mix of recycled/virgin fibers of the article being processed. As further shown in FIG. 1, each of corresponding segments of vapor conduits 34 and liquid conduits 36 are directly or serially interconnected via a common passageway formed in mounting blocks 38. In one embodiment, at least one vapor conduit 34 may extend from a regulated pressurized vapor source. In one embodiment, at least one liquid conduit 36 may extend from a regulated pressurized liquid source. As shown FIG. 1, regulators 74 may be separate from the pressurized sources.

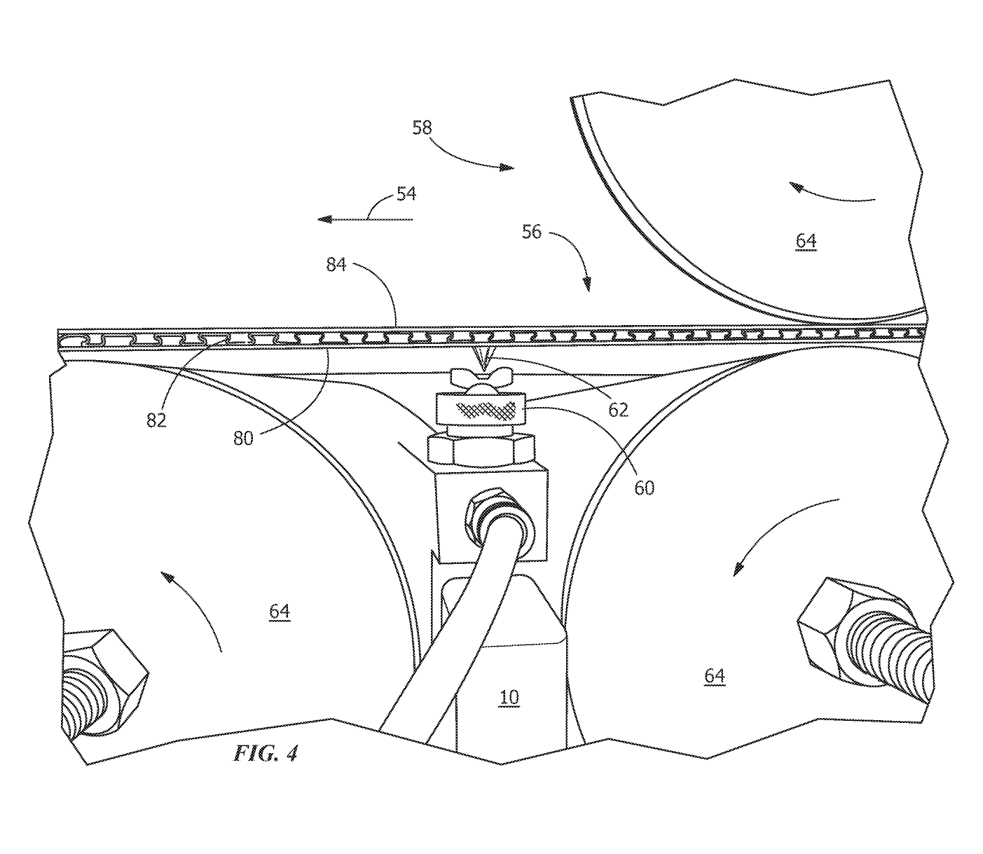

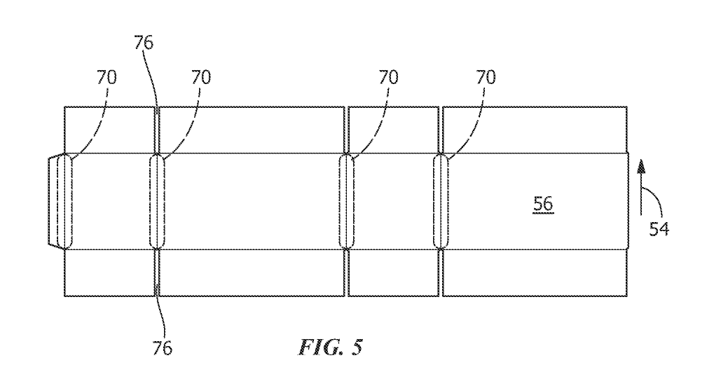

It is to be understood that pressurized vapor, such as air, and pressurized liquid, such as water, from the pressurized vapor source and the pressurized liquid source for producing pressurized mist may be selectably provided at different pressure levels and/or different temperatures. Such combinations of temperatures and pressures may be beneficial in providing optimal conditioning of predetermined portions 70 (FIG. 5) of one or more of liners 80, 84 and central medium 82 (FIG. 4) of corrugated fiberboard sheets 56 as will be discussed in further detail below.

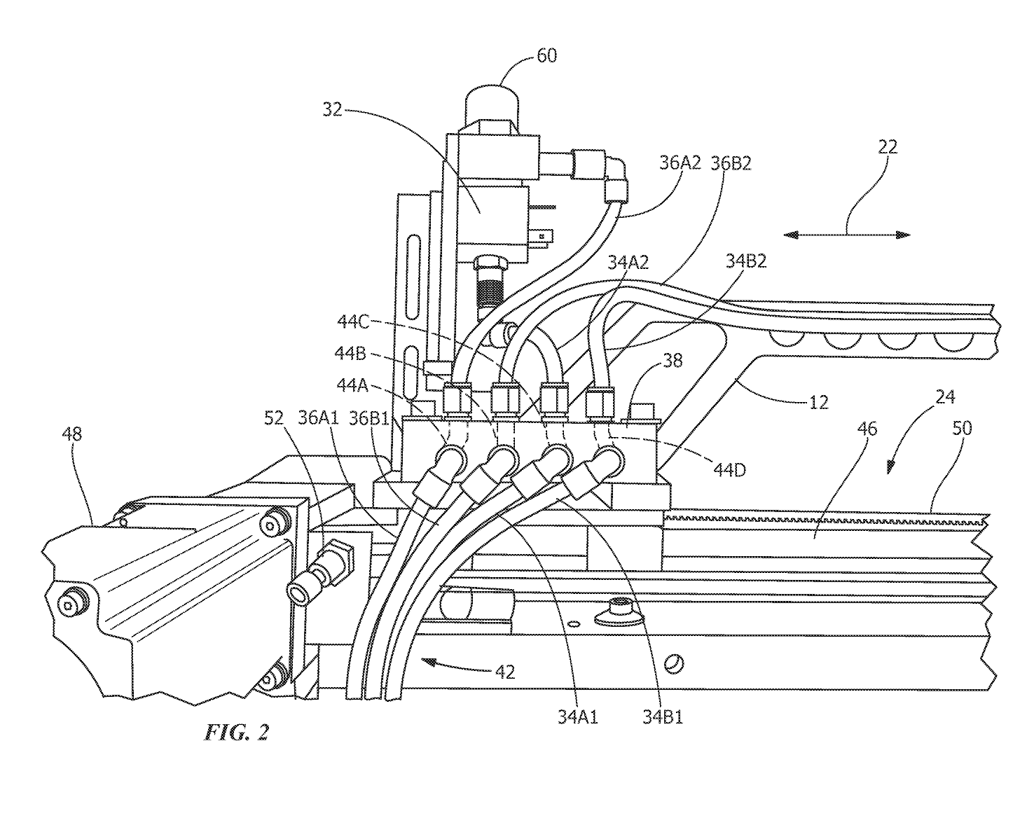

As further shown in FIG. 1, a conduit bundle 42 comprises vapor conduits 34 and liquid conduits 36 extending from the mounting block 38 that is secured to frame 20 toward the mounting block 38 which is secured to support member 12. As further shown in FIG. 2, which is a partial enlarged view taken from region 1 of FIG. 1, conduit bundle 42 includes vapor conduits 34A1, 34B1 and liquid conduits 36A1, 36B1 that are secured to mounting block 38. Vapor conduit 34A1 and vapor conduit 34A2 are maintained in fluid communication via passageway 44C formed in mounting block 38 for providing pressurized vapor to electro pneumatic valve 32 (shown in FIG. 2). Liquid conduit 36A1 and liquid conduit 36A2 are maintained in fluid communication via passageway 44A formed in mounting block 38 for providing pressurized liquid to electro pneumatic valve 32 (shown in FIG. 2). Vapor conduit 34B1 and vapor conduit 34B2 are maintained in fluid communication via passageway 44D formed in mounting block 38 for providing pressurized vapor to electro pneumatic valve 32 (not shown in FIG. 2). Liquid conduit 36B1 and liquid conduit 36B2 are maintained in fluid communication via passageway 44B formed in mounting block 38 for providing pressurized liquid to electro pneumatic valve 32 (not shown in FIG. 2). In other words, each of passageways 44A, 44B, 44C, 44D provide a single, direct, closed circuit, serial interconnection between corresponding segments of the same liquid conduit or vapor conduit that is provided to a particular electro pneumatic valve 32. This one-to-one closed circuit, serial interconnection arrangement for each liquid conduit and vapor conduit provides significantly greater control of the magnitude of pressure in each liquid conduit and vapor conduit compared to conventional open circuit, parallel interconnection arrangements involving manifolds having one or more inlets that are each in mutual fluid communication with a plurality of outlets.

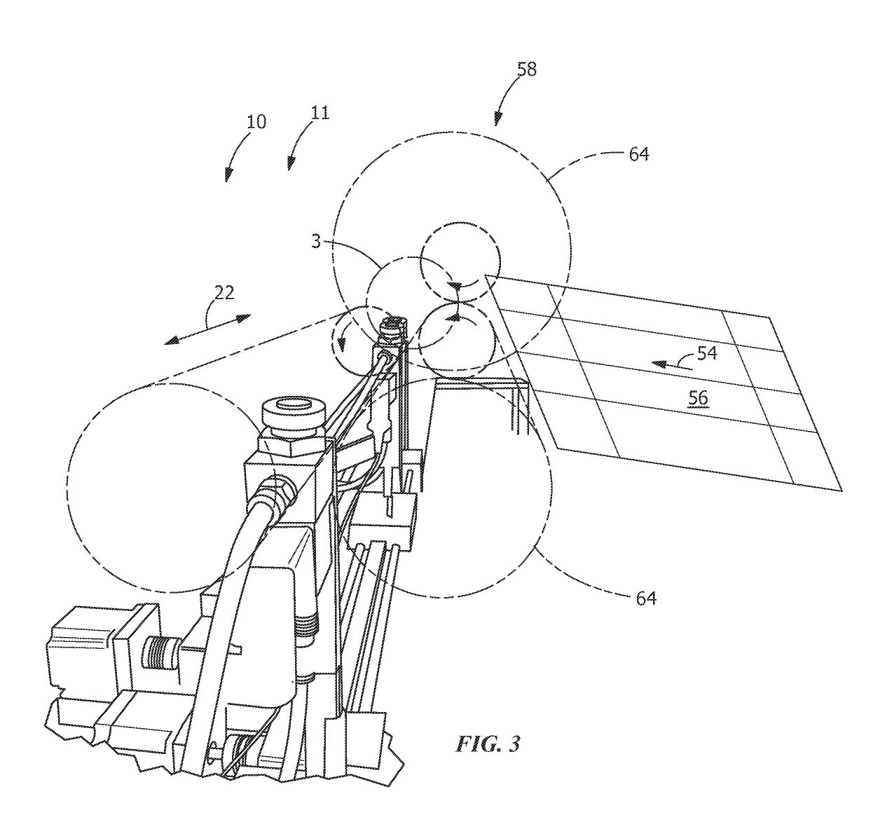

As further shown in FIG. 2, conveyor 24 includes a drive motor 48 drivingly secured to an endless drive belt 50 along one or more guide rails 46. Support member 12 is secured to drive belt 50 such that during operation, activation of drive motor 48 urges drive belt 50 support member 12 into movement along movement direction 22. As further shown in FIG. 1, support members 12, 14, 16, 18 are selectively urged into movement direction 22 by respective conveyors 24, 26, 28, 30, which is at an angle relative to the movement direction of an article that is to be processed during operation of the misting device. For example, as shown in FIG. 3, movement direction 22 of the conveyors is substantially perpendicular to article movement direction 54 of articles such as corrugated fiberboard sheets 56.

Electro pneumatic valves 32 comprise control of an electrical control system operating a pneumatic power system (not shown). In an exemplary embodiment, electro pneumatic valves 32 utilize solenoid valves which are used as an interface between the electrical and pneumatic systems. Devices, such as sensors 52 (FIG. 2), such as proximity sensors, limit switches and the like may be used as homing or feedback elements. In electro pneumatics, the signal medium is an electrical signal that may be provided from either an AC or DC electrical source, as desired. The working medium is a pressurized vapor, such as compressed air. Generally, resetting the position of electro pneumatic valve 32 may be achieved by spring (i.e., a single solenoid valve), using another solenoid (i.e., a double solenoid valve) or by pilot assisted solenoid actuation to reduce the size and cost of the valve, although other arrangements may be used.

An electrical control system may include relays and contactors, programmable logic controllers (PLCs), a combination of each (not shown), or other suitable components. A relay may be used to convert signal input from sensors and switches to a number of output signals, e.g., either normally closed or normally open valve positions. Signal processing can be easily achieved using relay and contactor combinations. A PLC can be conveniently used to obtain desired outputs as a result of the programmed logic, e.g., time delay and sequential operation. The output signals may be supplied to the electro pneumatic valves 32 for controlling their positioning.

Exemplary variables that can be controlled by the electrical control system include the width of the spray pattern of pressurized mist 62 (FIG. 4) from nozzle 60, the magnitude of pressurized vapor in vapor conduits 34 (FIG. 1), the magnitude of pressurized liquid in liquid conduits 36 (FIG. 1), the overlapping position the spray pattern extends relative to the span of a crease/fold area of corrugated fiberboard sheet 56 (FIG. 5), the spray pattern length, the start and stop of the spray pattern, and the distance of the nozzle 60 from the surface of facing liner 80 (FIG. 4) of corrugated fiberboard sheet 56. In one embodiment, nozzle 60 faces liner 84 that is opposite liner 80. In another embodiment, nozzles may be positioned facing each respective liner 80, 84.

An exemplary setup is provided as follows:
½ inch wide spray pattern;
50 psi (pressurized air);
10 psi (pressurized water);
¼ inch overlap of crease/fold area;
5 inch spray length;
½ inch start/stop delay; and
½ inch distance (distance between nozzle 60 and facing liner 80 (FIG. 4).

In one embodiment, the PLC may be configured or programmed to position the electro pneumatic valves 32 along movement direction 22 (FIG. 3) by use of conveyors 24, 26, 28, 30 (FIG. 1) to accommodate the size of the corrugated fiberboard sheets being processed, an encoder (not shown) of known construction for tracking machine speed in movement direction 54 (FIG. 4) and a photoelectric sensor 52. In this arrangement, the photoelectric sensor 52 senses/detects a leading edge of a corrugated fiberboard sheet traveling toward the nozzles 60 and calculates a distance prior to activating the pressurized mist 62, based on such input (e.g., pulses corresponding to machine speed in movement direction 54) that is measured by the machine speed encoder. An advantage of electro pneumatics is the integration of various types of proximity sensors and the PLC for highly effective control, as the electrically generated signal speed with electrical signal, can be much higher, cycle time can be reduced and the signal can be conveyed over long distances. In addition, application of the pressurized mist can be precisely controlled.

Referring to FIGS. 3 and 4, misting device 10 is incorporated into a device 11 for transforming corrugated fiberboard sheets 56 into containers such as boxes or cartons. Device 11 includes a pair 58 of counter rotating feed rollers 64 for controllably feeding corrugated fiberboard sheets 56 in movement direction 54 in close proximity above misting device 10. As corrugated fiberboard sheets 56 are passed above misting device 10, a pressurized mist 62 (FIG. 2) from nozzles 60 is selectively applied to liner 80 (FIG. 4), conditioning precise predetermined portions 70 (FIG. 5) of corrugated fiberboard sheets 56 having respective creases formed in the predetermined portions 70. That is, pressurized mist 62 is selectively provided substantially only to precise predetermined portions 70 of the corrugated fiberboard sheets. Stated another way, the flow of pressurized mist 62 to the corrugated fiberboard sheets is substantially prevented when nozzles 60 do not correspond to or are not in proximity with the predetermined portions 70, such as when nozzles 60 correspond to or are in proximity with the spacing between adjacent corrugated fiberboard sheets being fed into the device, as well as when nozzles 60 correspond to or are in proximity with slots 76 (FIG. 5). Once corrugated fiberboard sheets 56 have been fed in movement direction 22 past misting device 10, the corrugated fiberboard sheets 56 are immediately folded into containers by the device (not shown), while the precisely positioned predetermined portions 70 of corrugated fiberboard sheets are still “conditioned.”

It is to be understood that by virtue of selectively providing pressurized mist substantially only to a surface of the predetermined portion 70 of the corrugated fiberboard sheets 56, that virtually all of the pressurized mist is absorbed by the corrugated fiberboard sheets, which has advantages as compared to conventional water dispensing systems. For example, conventional uncontrolled, continuous water application systems, such as continuous gravity driven systems or pressurized water vessels application systems provide a stream of water continuously to the sheets, resulting in corrosion and other undesirable moisture related issues. Additionally, such conventional low pressure water dispensing systems have limited “conditioning” capabilities as compared to the system of the present disclosure which provides pressurized mist.

The term “conditioned” is intended to mean moistened or softened or otherwise rendered more pliable due to application of pressurized mist. While predetermined portions 70 (FIG. 5) of corrugated fiberboard sheets 56 having respective creases formed in the predetermined portions 70 are conditioned, the creasing heads (not shown) of conventional device 11 form inwardly directed folds in corrugated fiberboard sheet 56 by virtue of contact with a surface of liner 80 facing nozzle 60 (FIG. 4) of predetermined portions 70 during the converting process (from corrugated fiberboard sheet to a corrugated fiberboard container) during which damage to unconditioned fiberboard fibers can occur. The term “inwardly directed folds” in this context means that upon formation of the folds of corrugated fiberboard sheets 56 into a completed container, the surface of liner 80 corresponds to the resulting inside surface of the container. In another embodiment, the creasing heads (not shown) of conventional device 11 contact (for purposes of forming inwardly directing folds) a surface of liner 82 facing opposite nozzle 60 (FIG. 4) during the converting process.

In one embodiment, surface of liner 80 facing nozzle 60 of a predetermined portion 70 (FIG. 5) of corrugated fiberboard sheets 56 is conditioned immediately prior to and remains conditioned during the converting process. In another embodiment, both the surface of liner 80 facing nozzle 60 and a central medium 82 is conditioned immediately prior to and remains conditioned during the converting process. In yet a further embodiment, both the surfaces of liners 80, 82 (respectively facing nozzle 60 and facing opposite nozzle 60) as well as central medium 82 is conditioned immediately prior to and remains conditioned during the converting process. Therefore, the conditioned regions provide reduced opportunity for damage to creases being folded, as well as providing higher quality fiberboard containers, by virtue of the ability to more accurately control the location of the folds of the folding creases. While it is desirable that predetermined portions 70 remain conditioned during the converting process, the time period between application of the pressurized mist and the converting process spans a relatively brief period of time, such as between about 0.1 seconds to about 5 seconds, corresponding to conventional fiberboard processing devices. In another embodiment, the converting process may be extended to greater than 5 seconds, such as for corrugated fiberboard sheets having multiple layers.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for use with the manufacture of corrugated fiberboard products, comprising:
a first nozzle in close proximity to a corrugated fiberboard sheet having a crease formed in a predetermined portion of the sheet, the sheet moving relative to the first nozzle; and
a sensor for sensing a position of the sheet relative to the first nozzle;
wherein in response to the sensor sensing a predetermined position of the sheet relative to the first nozzle, a pressurized mist is selectively provided substantially only to a surface of the predetermined portion of the sheet facing the first nozzle prior to formation of a fold in the crease.

2. The apparatus of claim 1, wherein the pressurized mist conditions at least a first liner of the predetermined portion of the sheet facing the first nozzle.

3. The apparatus of claim 2, wherein the pressurized mist conditions a central medium of the sheet disposed between the first liner and a second liner.

4. The apparatus of claim 3, wherein the pressurized mist conditions the second liner of the predetermined portion of the sheet opposite the first liner.

5. The apparatus of claim 1, comprising a second nozzle positioned to face a surface of the sheet opposite the surface of the sheet facing the first nozzle.

6. The apparatus of claim 1, wherein the pressurized mist includes pressurized vapor.

7. The apparatus of claim 6, wherein the pressurized mist is substantially composed of water and air.

8. The apparatus of claim 6, wherein the pressurized mist includes pressurized liquid from a pressurized liquid source and pressurized vapor from a pressurized vapor source.

9. The apparatus of claim 8, wherein pressurized liquid from the pressurized liquid source and pressurized vapor from the pressurized vapor source are selectively providable at different pressure levels.

10. The apparatus of claim 1, wherein the predetermined portion of the surface of the sheet remains conditioned during formation of the fold.

11. The apparatus of claim 10, wherein the predetermined portion of the sheet remains conditioned a duration of between about 0.1 second and about 5 seconds.

12. The apparatus of claim 8, wherein pressurized liquid from the pressurized liquid source and pressurized vapor from the pressurized vapor source are selectively providable at different temperatures.

13. A method for manufacturing corrugated fiberboard products, comprising:
moving a fiberboard sheet having a crease formed in a predetermined portion of the sheet, the sheet in close proximity relative to a nozzle providing a pressurized mist;
sensing a predetermined position of the sheet relative to the nozzle;
selectively providing the pressurized mist substantially only to a surface of the predetermined portion of the sheet facing the nozzle for conditioning the predetermined portion; and
forming a fold in the crease.

14. The method of claim 13, wherein the pressurized mist conditions at least a first liner of the predetermined portion of the surface of the sheet facing the nozzle.

15. The apparatus of claim 14, wherein the pressurized mist conditions a central medium of the sheet disposed between the first liner and a second liner.

16. The apparatus of claim 15, wherein the pressurized mist conditions the second liner of the predetermined portion of the surface of the sheet opposite the first liner.

17. The apparatus of claim 13, wherein the pressurized mist includes pressurized liquid from a pressurized liquid source and pressurized vapor from a pressurized vapor source, the pressurized liquid and the pressurized vapor are selectively providable at different pressure levels.

18. The apparatus of claim 13, wherein the predetermined portion of the surface of the sheet remains conditioned during formation of the crease.

19. The apparatus of claim 18, wherein the predetermined portion of the surface of the sheet remains conditioned a minimum duration of between about 0.1 second and about 5 seconds.

20. A misting device comprising:
a nozzle in close proximity to an article moving relative to the nozzle; and
a sensor for sensing a position of the article relative to the nozzle;
wherein in response to the sensor sensing a predetermined position of the article relative to the nozzle, a pressurized mist is selectively provided substantially only to a surface of a predetermined portion of the article facing the nozzle prior to at least one subsequent processing step of the article;
wherein the predetermined portion of the surface is conditioned by the pressurized mist;
wherein the predetermined portion of the surface remains conditioned during the at least one subsequent processing step of the article.
